(19) United States
(12) Patent Application Publication
(10) Pub. No.: US 2019/0261622 A1
(43) Pub. Date: Aug. 29, 2019

(54) METHOD OF ATTRACTING WILDLIFE USING CUCURBIT OIL

(71) Applicant: Larry William Eckler, Niles, MI (US)

(72) Inventor: Larry William Eckler, Niles, MI (US)

(21) Appl. No.: 16/021,337

(22) Filed: Jun. 28, 2018

Related U.S. Application Data
(60) Provisional application No. 62/710,718, filed on Feb. 26, 2018.

(51) Int. Cl. A01M 31/00; A01K 85/01; A01K 97/04

(52) U.S. Cl. CPC A01M 31/008; A01M 2200/00; A01K 97/045; A01K 85/01

(57) ABSTRACT

A method of attracting wildlife is provided using the oil of a cucurbit seed. The cucurbit commonly used is pumpkin but can include other cucurbits, such as watermelon, cantaloupe, cucumbers, and squash. The oil is extracted from the seeds and screened. The extracted oil is later dispensed or dispersed at a location where the presence is desired but located outside of the physical reach of wildlife. The oil can be applied to mask the scent of human presence or human activity. The oil draws in wildlife from neighboring areas that are not accessible to hunters or enthusiasts, such as swamps, thickets, or areas with heavy brush. The oil may be used on fishing lures or bait to attract marine wildlife.

### CROSS REFERENCE TO RELATED APPLICATIONS

This application claims the benefit of U.S. Provisional Application No. 62/710,718, filed Feb. 26, 2018, the disclosures of which are hereby incorporated by reference.

### BACKGROUND OF THE INVENTION

This present disclosure relates to methods and devices used to attract wildlife either by masking the scent of a human or by dispersing a scent that is desirable to specific wildlife. Many devices and products available use components or compounds that have an offensive smell, such as doe or buck urine. The urine-based attractants will frequently only attract the male deer. Further, because urine can carry disease, including chronic wasting disease (CWD), urine attractants have been banned in some states with plans to ban it in others. Other attractants that are made from nuts, apples, or corn are frequently considered baits and are banned in many states. In the locations where this type of attractant is allowed, the attractants made from these products need to be replenished frequently, and are bulky and difficult to carry, especially out in the wilderness, where traversing terrain on foot is difficult enough, without having to carry extra weight. These include apples, corn seed, salt mineral blocks, acorns, and whole pumpkins. Not only deer, but other wildlife will eat these baits. These include birds, raccoon, mice, rats, and squirrels, necessitating more frequent replenishment. Other attractants or baits have limited shelf life or are only effective for a subset of the animals that the wildlife enthusiast is interested in attracting. Some of these require artificial additives to preserve their shelf life and others must be discarded after a short time. Therefore, an improved wildlife attractant is needed.

### SUMMARY OF THE INVENTION

The hunting regulations in many states do not allow baiting but allow scents and the use of attractants. The present disclosure describes the use of a cucurbit seed oil to attract wildlife, namely pumpkin, watermelon, cantaloupe, cucumbers, and squash seed oil. The seed oil from cucurbit plant fruits or gourds have been found to attract wildlife, but in particular, it attracts turkey, deer, elk, bear, wild pigs, moose, and caribou. The individual oils are extracted from the seeds by crushing and/or grinding, and then pressing to extract the oil. The oils may be blended with other cucurbit seed oils or used by themselves. Salt may be added or not used in addition. The oil may be dispersed in an area out of physical reach of the wildlife, such as a surface, placed into a dispenser, or applied to a media that allows the oil and scent to evaporate and disperse. Physical reach is defined as the wildlife being able to physically contact, lick, or touch in some way. As the oil evaporates, the scent is carried by the wind to where wildlife picks up the scent. The animal follows the scent to its source, where it investigates to see if any food is available, similar to the natural smell from ripening food sources such as acorns in a tree. Hunters and wildlife enthusiasts can observe or hunt the wildlife while it investigates. The oil draws in wildlife from neighboring areas that are not accessible to hunters or enthusiasts, such as restricted areas, swamps, thickets, or areas with heavy brush.

### DESCRIPTION OF THE PREFERRED EMBODIMENT

Wildlife uses their keen sense of smell to detect and avoid predators, mate, and locate food. Hunters, wildlife enthusiasts, and farmers have a desire or need to influence wildlife. For simplicity, deer (bucks and does) will be the wildlife described herein, but the oil and method described herein can be used to attract turkey, elk, bear, wild pigs, moose, and caribou. Cervids, which include deer, elk, reindeer, and moose, are attracted to the smell. The oil can also be applied to fishing lures and baits to attract marine wildlife.

The scent of cucurbit oil is desirable to deer because they are drawn to cucurbits as a food source high in protein. The fruit and plants give off a scent naturally, but the scent in the seeds is much stronger, which is picked up by the wildlife. The wildlife is drawn to the source of the scent, where it searches for the presence of food. Wildlife will not linger in the area where food is not accessible. Lingering wildlife can raise the chances of the spread of disease through contact with bodily fluids (such as blood or saliva) and waste (such as feces or urine). Unlike baits that allow muzzle to muzzle contact where the wildlife eat, this method of using cucurbit oil to attract wildlife decreases the rise of diseases that are spread using baits and foods. CWD is caused by Prions, an abnormal form of protein that attacks the nervous system of cervids, which includes deer, elk, reindeer, and moose. CWD results in death of the animal and can be transmitted directly or indirectly. Cucurbit oil does not contain prions, which are known to cause CWD.

It is sometimes desirable to mask the scent given off by the human body, particularly for wildlife enthusiasts and hunters, as wildlife frequently avoids human contact.

To manufacture the attractant, the first step involves harvesting the seeds from the cucurbit plant. The seeds are separated from the fruit and cleaned. To harvest the seeds, the user may employ a manual process or utilize a machine that separates the seeds. Commercially available seed harvesters are one example of a machine that is commonly used to separate the seeds from the fruit.

The next step is to dry the seeds. The drying time for the seeds will vary depending on the type of seed and the desired moisture content. Drying the seeds will allow them to be properly pressed for oil extraction. Any “blank” seeds are removed at the end of the drying process. Blank seeds do not have the protein-rich material and oil and commonly consist of only a shell. The seeds are commonly dried to a preferred moisture level of 5 to 7 percent, but other moisture levels may be used. Having an acceptable moisture content allows the oil to be extracted and processed by seed pressing equipment. Unacceptable moisture content causes oil degradation, low oil output, machine malfunction, or water mixed extracted oil.

Next, the seeds are placed into a seed oil press that crushes them and separates the seed into oil and cake. The seed oil press presses the ground up seeds, leaving behind a cake minus most of the oil. The cake is the leftover portion of the crushed seed, which still has small amounts of oil residue remaining.

Optionally, the oil may undergo filtration or another refinement process to remove any suspended particulates or impurities leftover from the pressing/extraction operation. The oil may be refined by sedimentation, where heavier particles will settle and collect on the bottom of a storage vessel over time, and the clear oil can then be poured off. Filtration may be needed if the oil is going to be sprayed, as any contamination or suspended particles may clog a spray nozzle.

The oil, as processed, may be combined with other cucurbit seed oils and blended. Once blended, it is placed into containers for transportation, storage, and use. The containers are commonly dark-colored to prevent degradation from light and are stored in a cool area away from direct light to increase shelf life. The containers may include a flip-top, disc top, pump, squeeze, or spray bottle. A container mated with a wicked lid may be used. Pumpkin oil is the most commonly used cucurbit oil due to its availability and wildlife attractant properties. As previously stated, other cucurbit oils may be blended with pumpkin oil.

To attract wildlife, the oil is dispensed from a container through one or several means. For example, the oil can be sprayed through an atomizer or common spray bottle onto a surface that is within the scent range but out of reach of the desired wildlife animal. The oil can also be poured onto a rag, cloth, sponge, felt pad, or other absorbent material that allows the oil to evaporate and disperse the scent. In such a case, the absorbent material acts as a dispenser that disperses the oil into the air. These are also known as scent strips or pads. Another option is a commonly available wicked container which can be used to disperse the oil scent over a long period of time, depending on the size of the wick and the volume of oil in the container. In a wicked container, there is an internal chamber that is preferably impervious to the oil contained therein. The chamber has an opening that can receive a removable lid. The chamber holds a quantity of oil on the inside. The outside of the chamber is exposed to ambient air that will ultimately carry the scent to the wildlife. A wick is commonly captured by the lid causing it to extend from above the lid while being partially submerged in the oil inside the chamber. The oil soaks up through the wick and saturates it, where it is exposed to the air outside the chamber. The oil then evaporates into the air, dispersing the scent where it can be detected by wildlife. Wind will carry the scent from the wick. To prevent the wildlife from lingering or to prevent saliva contact, the dispensing point of the oil should be out of reach of the wildlife. If the oil (either through a dispenser or having been sprayed on a surface) is within the reach of wildlife, they may lick the surface or dispenser, other wildlife showing up later may lick the same surface, potentially causing the spread of disease. To clarify, the dispenser remains out of the reach of the particular wildlife the hunter or wildlife enthusiast is trying to attract. In many cases, the wildlife is deer, an animal having a reach from the ground as far as seven feet (or just over two meters), so the dispenser has to be located above this height. Other types of wildlife that may be attracted will have different height requirement, and the hunter or wildlife enthusiast may have to place the dispenser at a different height to accommodate.

The cucurbit oils may be used by marine wildlife enthusiasts, including those that enjoy fishing for sport or as a leisure activity. Fish are attracted to the scent of cucurbit oils. Fishing involves lures and/or bait to attract the fish to bite down on a hook or barb that allows the fisherman to pull the fish out of the water. When applied to the bait or lure, cucurbit oil further enhances the attractive nature of the lure and/or bait. The oil may be sprayed, rubbed, or otherwise applied to the bait or lure. When the bait or lure is cast and falls into the water, the scent of the oil is dispersed, where it is picked up by the olfactory (smell) senses of the fish. The fish follow the scent, where they notice the lure or bait.

These cucurbit oils including pumpkin, squash, gourd, cucumber, and pickles should be placed out the same day the hunter will be hunting or wildlife enthusiast desires to observe wildlife. This presents a new scent to the wildlife, creating a high level of curiosity. At the end of the hunting or wildlife observation day, the user should retrieve the scent containers and/or absorbent materials where the oils were applied. The user may save the materials for the next hunting day. The retrieval of the oil-scented materials keeps deer and other animals from visiting that area when the hunter or enthusiast is not present. Further, retrieval of the materials lessens deer discouragement from visiting the scented area if left for several days with no food available.

Because the oil is extracted from seeds, the oil biodegrades in the environment in a similar manner. Further, the oil contains natural preservatives, and therefore, does not need artificial preservatives that would alter the scent or impact the environment. The oil is naturally antimicrobial. Because the oil is not water-soluble, any precipitation (such as rain, snow, or sleet) is less likely to rinse the scent away or move the oil down into an area where the wildlife can access it.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A method of attracting wildlife comprising:
providing the seeds of a cucurbit genus of plant drying said seeds to an acceptable moisture content;
extracting oil from said seeds;
applying said oil to a dispenser; and
locating said dispenser in a location at which said wildlife is desired to be attracted.

2. The method of attracting wildlife in claim 1, wherein said location is outside the physical reach of said wildlife.

3. The method of attracting wildlife in claim 2, wherein said wildlife includes cervids.

4. The method of attracting wildlife in claim 1, wherein said dispenser is a fishing lure and said wildlife is marine wildlife.

5. The method of attracting wildlife in claim 1, wherein said cucurbit genus is pumpkin.

6. The method of attracting wildlife in claim 1, wherein said dispenser has a chamber for storing said oil, said dispenser having a wick, said wick extending from inside said chamber to outside said chamber, said wick for carrying said oil from said chamber to said outside.

7. The method of attracting wildlife in claim 1, wherein said dispenser is an absorbent material.

8. A method of attracting wildlife comprising:
providing a wildlife attractant comprising an oil from the seeds of a cucurbit genus of plant, wherein said oil is present in a form and amount effective to attract wildlife; and
dispensing said amount in an area near a location at which said wildlife is desired to be attracted.

9. The method of attracting wildlife according to claim 8, wherein said area is located out of the physical reach of said wildlife.

10. The method of attracting wildlife in claim 9, wherein said wildlife includes cervids.

11. The method of attracting wildlife in claim 8, wherein said cucurbit genus is pumpkin.

12. The method of attracting wildlife in claim 8, wherein said dispenser has a chamber for storing said oil, said dispenser having a wick, said wick extending from inside said chamber to outside said chamber, said wick for carrying said oil from said chamber to said outside.

13. The method of attracting wildlife in claim 8, wherein said dispenser is an absorbent material.

14. The method of attracting wildlife in claim 8, wherein said dispenser is a fishing lure and said wildlife is marine wildlife.

15. The method of attracting wildlife in claim 8, wherein said dispenser is fishing bait and said wildlife is marine wildlife.

16. A method of attracting wildlife comprising:
providing a wildlife attractant comprising an oil from the seeds of a cucurbit genus of plant, wherein said oil is applied to a present in a form and amount effective to attract wildlife; and
dispensing said amount in an area near a location at which said wildlife is desired to be attracted, said area is located out of the physical reach of said wildlife.

17. The method of attracting wildlife in claim 16, wherein said cucurbit genus is pumpkin.

18. The method of attracting wildlife in claim 17, wherein said wildlife includes cervids.

19. The method of attracting wildlife in claim 16, wherein said dispenser has a chamber for storing said oil, said dispenser having a wick, said wick extending from inside said chamber to outside said chamber, said wick for carrying said oil from said chamber to said outside.

20. The method of attracting wildlife in claim 16, wherein said dispenser is an absorbent material.
